(19) United States
(12) Patent Application Publication
(10) Pub. No.: US 2026/0266316 A1
(43) Pub. Date: Sep. 10, 2026

(54) HYDRAULIC CYLINDER WITH CARBON FIBER

(71) Applicant: Milwaukee Electric Tool Corporation, Brookfield, WI (US)

(72) Inventors: Patrick C. Jalabert, Brookfield, WI (US); Jacob Nemec, Brookfield, WI (US); Mathew R. Rentmeester, Wauwatosa, WI (US); Benjamin J. Tretow, Mequon, WI (US)

(21) Appl. No.: 19/556,480

(22) Filed: Mar. 4, 2026

Related U.S. Application Data
(60) Provisional application No. 63/767,356, filed on Mar. 5, 2025.

(51) Int. Cl. F15B 15/14; B25D 9/00

(52) U.S. Cl. CPC F15B 15/1428; B25D 9/00; F15B 2215/305

(57) ABSTRACT

A hydraulic cylinder for a hydraulic tool includes a cylinder defining an axis. The cylinder includes a tube comprising carbon fiber and a liner disposed within the tube to define an interior surface of the cylinder. The liner includes a first end that extends out of the tube. The first end defines a port extending through the liner at an oblique angle relative to the axis. A piston is moveably disposed within the cylinder. The piston includes a piston head that seals against the interior surface of the liner and a rod that extends out of the cylinder.

### CROSS-REFERENCE TO RELATED APPLICATIONS

This application claims the benefit of and priority to U.S. Provisional Patent Application No. 63/767,356, filed on Mar. 5, 2025, which is incorporated herein by reference in its entirety.

### FIELD

The present disclosure relates generally to power tools. More specifically, the present disclosure relates to a hydraulic cylinder.

### BACKGROUND

Hydraulic tools generally include a hydraulic cylinder that generates an output force to perform work on a workpiece (e.g., a cut, a crimp, or a punch). Hydraulic tools can be heavy or bulky around the hydraulic cylinder making it hard to use.

### SUMMARY

According to one aspect of the present disclosure, a hydraulic cylinder for a hydraulic tool can be provided. The hydraulic cylinder can include a cylinder defining an axis. The cylinder can include a tube comprising carbon fiber and a liner disposed within the tube to define an interior surface of the cylinder. The liner can include a first end that extends out of the tube. The first end can define a port extending through the liner at an oblique angle relative to the axis. A piston can be moveably disposed within the cylinder. The piston can include a piston head that seals against the interior surface of the liner and a rod that extends out of the cylinder.

In some examples, the piston head can separate an interior space of the cylinder into a first chamber and a second chamber, and the port can be provided at the first chamber.

In some examples, the rod can extend into the first chamber and through the first end of the liner.

In some examples, the cylinder can be provided within a housing of a power tool and the first end of the liner can be configured to couple to a working head of the power tool.

In some examples, the second chamber can include a return mechanism and a retention cap can secure the return mechanism within the second chamber.

In some examples, a first ratio of a wall thickness of the tube to a wall thickness of the liner can be about 2:1 at the first chamber.

In some examples, a second ratio of the wall thickness of the tube to the wall thickness of the liner can be greater than 2:1 at the second chamber, and a third ratio of the wall thickness of the tube to the wall thickness of the liner can be less than 2:1 at the first end of the liner.

In some examples, the liner can be a metallic tube that is disposed within the tube.

In some examples, the tube can include a first layer having carbon fiber strands oriented with a first wrap angle relative to the axis and a second layer having carbon fiber strands oriented with a second wrap angle relative to the axis that is different from the first wrap angle.

In some examples, an end of the tube can be disposed along the port in an axial direction parallel to the axis.

According to another aspect of the present disclosure, a hydraulic tool can be provided. The hydraulic tool can include a housing and a working head coupled to the housing. The hydraulic tool can include a hydraulic cylinder defining a cylinder axis. The hydraulic cylinder can include a liner defining an interior surface of the hydraulic cylinder and a tube disposed around the liner. The tube can include a first layer having carbon fiber strands oriented with a first wrap angle relative to the cylinder axis and a second layer having carbon fiber strands with a second wrap angle relative to the cylinder axis. A piston can be moveably disposed within the hydraulic cylinder. The piston can include a piston head that seals against the interior surface of the liner to separate an interior space of the hydraulic cylinder into a first chamber and a second chamber. A port can be defined in the liner.

In some examples, the port can be provided at the first chamber and can extend at an oblique angle from the cylinder axis so that an axis of the port intersects the cylinder axis.

In some examples, the port can extend through the liner from a first end to a second end so that the first end of the port is disposed within the tube and the second end is disposed outside the tube.

In some examples, the first wrap angle can be about 90 degrees.

In some examples, the second wrap angle can be about 45 degrees.

In some examples, the first wrap angle can be variable along the cylinder axis.

In some examples, the liner can be made from carbon fiber with a coating that is at least one of oil-based, metallic, ceramic, or polymer.

According to yet another aspect of the present disclosure, a hydraulic cylinder for a hydraulic tool can be provided. The hydraulic cylinder can include a cylinder defining an axis. The cylinder can include an outer tube comprising carbon fiber and an inner tube defining an interior surface of the cylinder. The inner tube can be received within the outer tube and can include a variable wall thickness. A piston can be moveably disposed within the cylinder. The piston can include a piston head sealing against the interior surface of the inner tube and separating an interior space of the cylinder into a first chamber and a second chamber, and a rod extending out of the cylinder. The inner tube can define a first length between a first inner tube end and a second inner tube end and the outer tube can define a second length between a first outer tube end and a second outer tube end. The first length and the second length can define a ratio greater than about 4:3.

In some examples, the inner tube can define a first end that extends out of the outer tube and a second end that aligns with a second end of the outer tube.

In some examples, the first end of the inner tube can define a flange that abuts the outer tube.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is an axonometric view of a hydraulic tool, according to aspects of the present disclosure.

FIG. 2 is a schematic diagram of the hydraulic tool of FIG. 1.

FIG. 3 is a top view of a hydraulic actuator of the hydraulic tool of FIG. 1.

FIG. 4 is a cross-sectional view of the hydraulic actuator of FIG. 3, taken along IV-IV.

FIG. 5 is a cross-sectional view of another hydraulic actuator of the hydraulic tool of FIG. 1.

FIG. 6 is a top view of another hydraulic actuator of the hydraulic tool of FIG. 1.

FIG. 7 is a cross-sectional view of the hydraulic actuator of FIG. 5, taken along VI-VI.

### DETAILED DESCRIPTION

Hydraulic tools generally include a hydraulic cylinder that generates an output force to perform a work function on a workpiece (e.g., a cut, a crimp, or a punch). Conventional hydraulic tools generally utilize hydraulic pressure to move a piston within a cylinder between a first position and a second position. In some examples, the hydraulic tool is a single-acting cylinder that creates force in a first direction. In other examples, the hydraulic tool is a double-acting cylinder that creates force in a first direction and a second direction. In some cases, the first direction corresponds with extension of the piston, and the second direction corresponds with retraction of the piston, or vice versa.

Hydraulic tools can be heavy or bulky around a hydraulic cylinder making it hard for a person to use. Accordingly, a multi-component hydraulic cylinder can balance the weight with strength. In some cases, the multi-component hydraulic cylinder can have an outer tube with one material, and an inner tube of another material. The inner tube can be a separate component that is inserted into the outer tube or a separate component that the outer tube can be wrapped around. In some cases, there can be intermediate layers between the inner tube and the outer tube. In some cases, a coating can be provided on an inner surface of the inner tube to improve wear and friction characteristics. The outer tube can be made from carbon fiber or another material that can provide the required strength while also being lighter weight, as compared with a cylinder made entirely of the material of the inner tube. For example, the carbon fiber provides strength and reduces weight of the cylinder while the inner tube can be made from a metallic layer (e.g., aluminum, steel, etc.) that improves wear and friction.

In some aspects, the carbon fiber used for the outer tube may be selected from various types based on desired performance characteristics. For example, high modulus carbon fiber may be used where stiffness is prioritized, intermediate modulus carbon fiber may be used to balance stiffness and strength, and standard modulus carbon fiber may be used where cost considerations are relevant. The carbon fiber tows used in the wrapping process may have varying numbers of filaments, such as 3K (3,000 filaments), 6K, 12K, or 24K tows, with larger tow sizes generally providing faster manufacturing while smaller tow sizes may offer improved surface finish and more precise fiber placement. In some cases, the wrap pattern may be continuous, where the carbon fiber is wrapped in an uninterrupted helical pattern around the inner tube. In other cases, the wrap pattern may be discontinuous, where discrete sections of carbon fiber are applied to specific regions of the cylinder to provide localized reinforcement.

The present disclosure implements carbon fiber as the outer tube. More specifically, carbon fibers can be wrapped in multiple layers to achieve the desired strength characteristics. In some cases, the individual carbon fibers that form each layer can be wrapped at a desired wrap angle to balance axial and circumferential strength of the tube. Where multiple layers are used, the wrap angle for the various layers can be modified, such that some layers have a first wrap angle, while other layers have a second wrap angle. For example, the outer tube can include a first layer having carbon fiber strands oriented with a first wrap angle relative to a cylinder axis. The outer tube can also include a second layer having carbon strands oriented with a second wrap angle relative to the cylinder axis that is different from the first wrap angle. The multi-component cylinder can also have variable wall thickness to reduce weight while maintaining strength in areas subject to high pressures or loads. For example, the wall thickness of the outer tube to the wall thickness of the inner tube is about 2:1 at a first chamber. Correspondingly, some layers may extend an entire axial length of the inner tube, while some layers may only extend part of an axial length of the inner tube. Such arrangement provides improved strength in high stress regions, while minimizing excess weight in lower stress areas.

In some examples, the individual layers of the outer tube may have varying thicknesses depending on the structural requirements at different locations along the hydraulic cylinder. For instance, layers in regions subject to higher pressures or loads may be thicker than layers in lower stress regions. In some cases, certain layers may extend only partially along the axial length of the inner tube, providing additional reinforcement in high-stress areas without adding unnecessary weight to lower-stress regions. The total number of layers in the outer tube may vary based on the pressure requirements of the hydraulic cylinder. For example, a hydraulic cylinder designed for lower operating pressures may include two or three layers, while a hydraulic cylinder designed for higher operating pressures may include four, five, six, or more layers. The selection of the number of layers, their respective thicknesses, and their axial extent may be optimized to achieve a desired balance between strength, weight, and manufacturing considerations.

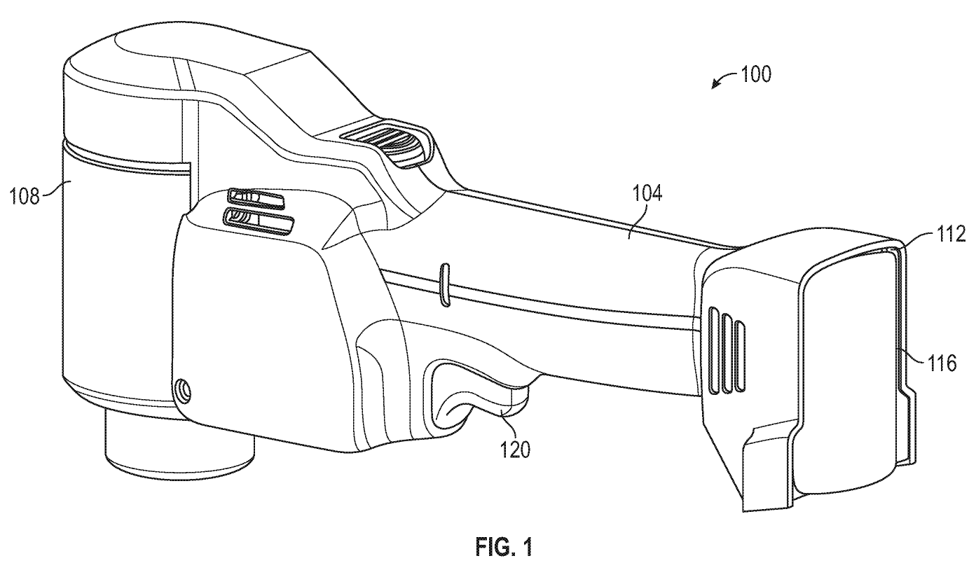

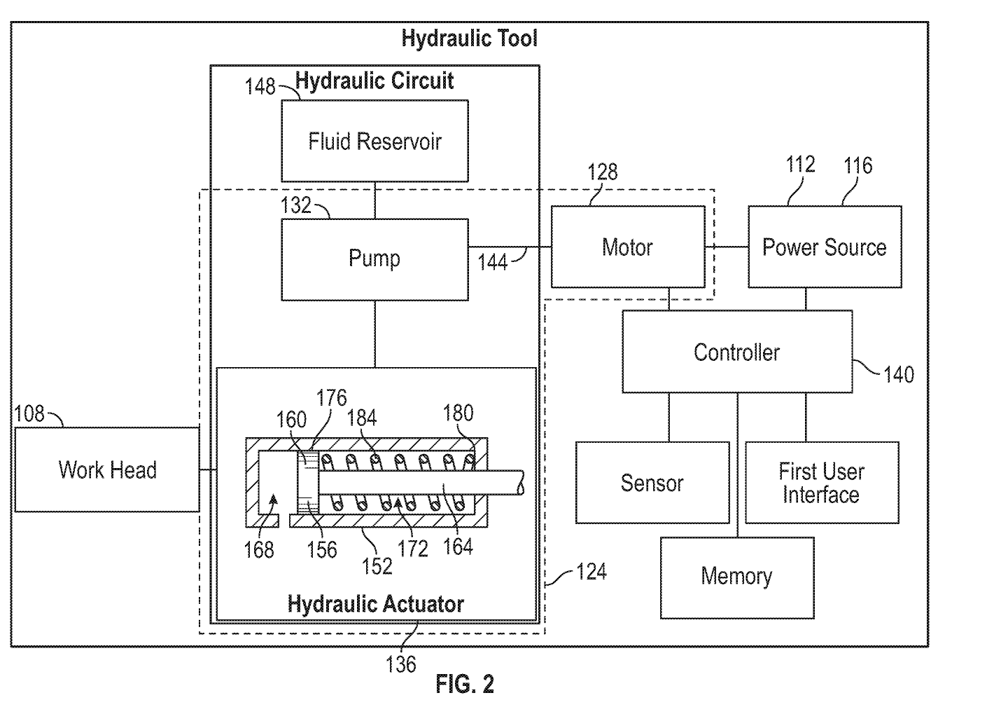

FIGS. 1 and 2 illustrate an example of a hydraulic tool 100, in accordance with the present disclosure. Although the example implementation described herein depicts a knockout tool, the features of this disclosure can be implemented in other similar tools, such as cutting tools or crimping tools. In addition, any suitable size, shape or type of elements or materials could be used. The illustrated hydraulic tool 100 includes a housing 104 and a working head 108 that is coupled to the housing 104 to perform an operation on a work piece. The working head 108 is illustrated as a punching head; however other types of working heads can also be used. In some examples, the hydraulic tool 100 can be battery operated and the housing 104 can define a battery receptacle 112 that is configured to receive a battery 116. In other examples, the hydraulic tool 100 can be corded.

To operate the hydraulic tool 100, a trigger 120 is coupled to the housing 104. The trigger 120 can be manipulated by a user to actuate the hydraulic tool 100 and perform the work operation. For example, actuating the trigger 120 can control operation of an output assembly 124 that is disposed within the housing 104. The output assembly 124 includes a motor 128, a pump 132, and a hydraulic actuator 136 that acts on the working head 108 to perform the work operation. When the trigger 120 is pressed, electrical current can flow from the battery 116 to the output assembly 124, causing the output assembly 124 to operate the working head 108 to perform the work operation. In some cases, the trigger 120 can communicate with an electronic controller 140 that controls a flow of electrical current from the battery 116 or another power source. More specifically, the electrical current can be provided to the motor 128 of the output assembly 124. The motor 128 can be coupled to the pump 132 so that rotation of the motor 128 operates the pump 132 to supply pressurized hydraulic fluid to the hydraulic actuator 136. In some cases, the motor 128 can be coupled to the pump 132 via a transmission 144 (e.g., a gear reducer).

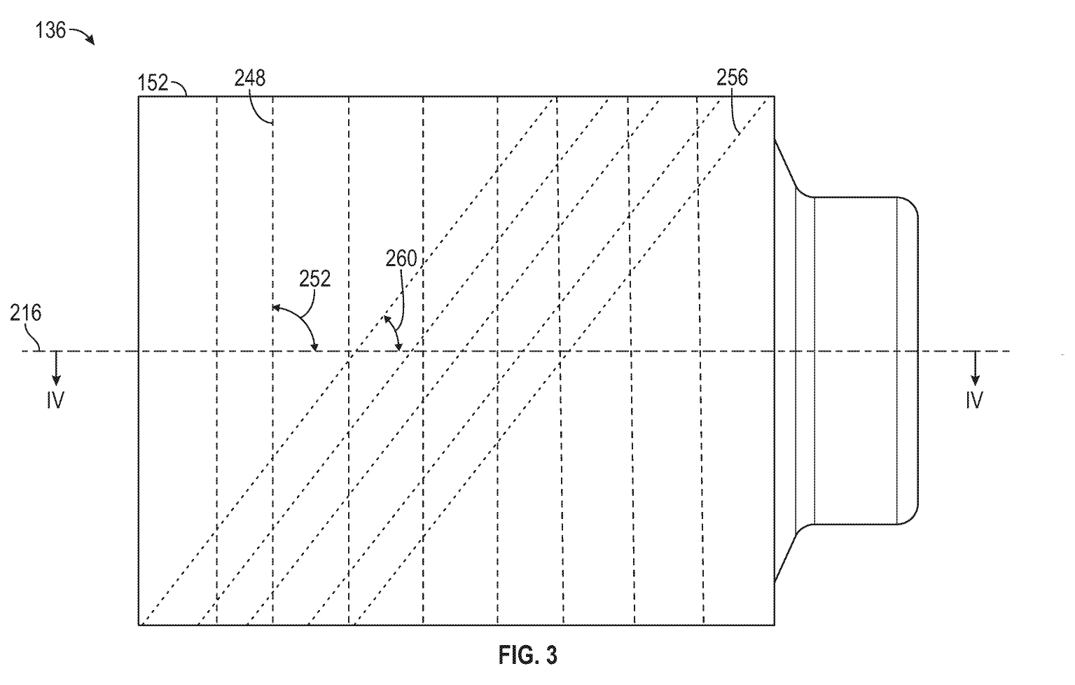

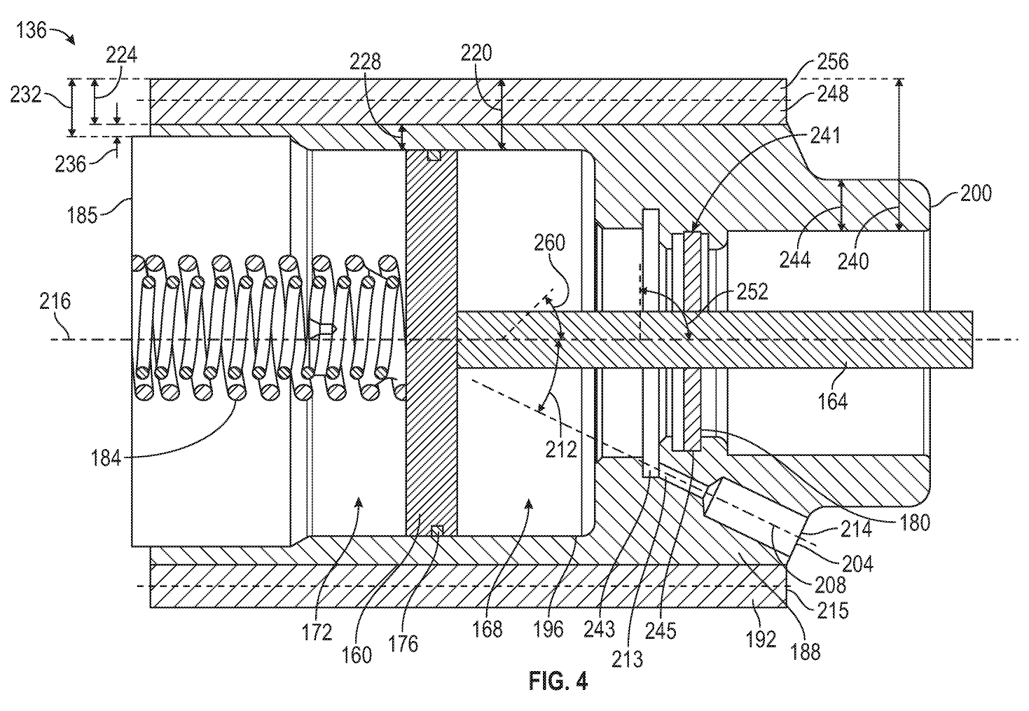

With additional reference to FIGS. 3 and 4, the hydraulic tool 100 includes the hydraulic actuator 136. The pump 132 supplies hydraulic fluid from a reservoir 148 (e.g., a tank) to a hydraulic cylinder 152. In general, the hydraulic actuator 136 includes a piston 156 having a piston head 160 and a piston rod 164. The piston 156 is moveably received in the hydraulic cylinder 152 to form a first chamber 168 and a second chamber 172 within the internal volume of the hydraulic cylinder 152. A piston seal 176 is provided to seal between the piston head 160 and the hydraulic cylinder 152 to prevent fluid from leaking between the first chamber 168 and the second chamber 172. A rod seal 180 is provided to seal between the hydraulic cylinder 152 and the piston rod 164 to prevent hydraulic fluid from leaking out of the hydraulic actuator 136.

To operate the hydraulic actuator 136, the hydraulic cylinder 152 uses pressurized fluid to create mechanical motion. For example, hydraulic fluid is pumped into the first chamber 168. The pressure acting on the surface area of the piston 156 generates a force that causes the piston 156 to move within the hydraulic cylinder 152 between a first position (e.g., a retracted position or an extended position) and a second position (e.g., the other of the retracted position and the extended position). In some cases, the hydraulic actuator 136 is single acting. For example, hydraulic fluid is pumped to apply pressure to one side (e.g., first chamber 168) of the piston 156. Therefore, the piston 156 moves in a first direction (e.g., for extension or retraction) by the generation of the force from the first position to the second position. A return mechanism 184 (e.g., spring or gravity) is used to return the piston 156 from the second position to the first position and is secured by a retention cap 185, shown in FIG. 4. As fluid leaves the first chamber 168, the return mechanism 184 causes the piston 156 to move in the opposite, second direction (e.g., for the other of extension or retraction) from the second position to the first position. In other cases, the hydraulic actuator 136 is double-acting. For example, hydraulic fluid is pumped to apply pressure to both sides (e.g., the first chamber 168 and a second chamber 172) of the piston 156. Hydraulic fluid creates pressure along the surface in the first chamber 168, generating a force to move the piston 156 between the first position and the second position.

Generally, hydraulic tools can be heavy or bulky because a hydraulic cylinder may use material to compensate for the working pressure of the hydraulic fluid. The hydraulic cylinder may use more material for higher working pressures, thus making the hydraulic tool heavy and hard to use. The present disclosure provides a multi-component hydraulic cylinder that balances the weight with strength and can enable higher operating pressures without a size increase (e.g., diameter, axial length, weight, etc.).

A multi-component hydraulic cylinder can balance the weight of a hydraulic tool with strength by including an outer tube and an inner tube. The inner tube is disposed within the outer tube to define an interior surface of a hydraulic cylinder. The inner tube is made of a first material to provide wear resistance and reduce frictional losses. The outer tube provides additional strength and is made of a second material with a higher strength-to-weight ratio to reduce weight of the cylinder, as compared with a cylinder having similar strength but made of only the first material. Referring to FIG. 4, an inner tube 188 (e.g., a liner) is disposed within an outer tube 192 (i.e., a tube) to define an interior surface 196 of the hydraulic cylinder 152. The inner tube 188 defines a first end 200 that extends out of the outer tube 192 and is configured to couple to a working head 108 of the hydraulic tool 100. The piston 156 is moveably disposed within the hydraulic cylinder 152. The piston 156 includes the piston head 160 that seals against the interior surface 196 of the inner tube 188 and the piston rod 164 that extends into the first chamber 168 through the first end 200 of the inner tube 188. The first end 200 defines a port 204 extending through the inner tube 188.

In some aspects, the inner tube may be inserted into a pre-formed outer tube. For example, the outer tube may be manufactured separately as a carbon fiber tube, and the inner tube may then be press-fit or slip-fit into the interior of the outer tube. In other aspects, the outer tube may be wrapped directly onto the inner tube. For example, carbon fiber tows may be wound around the outer surface of the inner tube using a filament winding process, and the wrapped assembly may then be cured to form the outer tube in place around the inner tube. In some cases, an adhesive may be used to secure the inner tube to the outer tube. The adhesive may be an epoxy-based adhesive, a structural adhesive, or another suitable bonding agent. In other cases, an interference fit may be used to secure the tubes together, where the inner tube is sized slightly larger than the inner diameter of the outer tube such that the tubes are held together by friction. In some examples, surface preparation may be performed on the outer surface of the inner tube prior to assembly with the outer tube. Surface preparation may include cleaning, degreasing, roughening, priming, or applying a bonding agent to improve adhesion between the inner tube and the outer tube.

A port can be provided at a first chamber in a hydraulic cylinder to allow fluid in and out of the chamber to allow for extension and retraction of the piston. The port can be positioned or oriented so that the port is provided in an inner tube rather than through an outer tube. Such arrangement can provide improved structural integrity of the outer tube and allow for more robust connections of valves or other flow control elements that may be installed in the port. That is, for example, carbon fiber may, in some cases, require a metal insert to provide a threaded or other connection to a flow control element, whereas threads or a press fit hole can be provided directly in a metal material of an inner tube. For example, FIG. 4 shows the port 204 provided at the first chamber 168 to allow fluid in and out of the first chamber 168. In some cases, the port 204 extends through the inner tube 188 to the first chamber 168 to define a port axis 208. The port 204 extends at an oblique angle 212 relative to a cylinder axis 216 (e.g., an extension axis) of the hydraulic cylinder 152. For example, the angle 212 is about 25 degrees. In some cases, the angle 212 is between about 15 to 20 degrees, about 20 to 25 degrees, about 25 to 30 degrees, or angle greater than 0 degrees and less than 90 degrees without interfering with the outer tube 192. In some cases, the port 204 can be threaded or be sized to receive a valve or other flow control element. The angle 212 of the port 204 allows the port 204 to extend past the end of the outer tube 192. That is, a first end 213 of the port 204 at the first chamber 168 is axially aligned to be within the outer tube 192, while a second end 214 of the port 204 is positioned beyond an end 215 of the outer tube 192. Thus, the end of the outer tube 192 is between the first end 213 and the second end 214 of the port 204 along the axial direction (e.g., relative to axis 216).

A multi-component hydraulic cylinder can have a variable wall thickness to reduce weight while maintaining strength in areas subject to high pressures. For example, FIG. 4 shows a first ratio 220 of a wall thickness 224 of the outer tube 192 to a wall thickness 228 of the inner tube 188 is about 2:1 at the first chamber 168. In some examples, the first ratio 220 is between about 5:1 and about 4:1, between about 4:1 and about 2:1, between about 2:1 and about 1:1, greater than about 1:1, or any other range. A second ratio 232 of the wall thickness 224 of the outer tube 192 to a wall thickness 236 of the inner tube 188 is greater than about 2:1 at the second chamber 172. In some examples, the second ratio 232 is between about 5:1 and about 4:1, between about 4:1 and about 2:1, between about 2:1 and about 1:1, or any other range. A third ratio 240 of the wall thickness 224 of the outer tube 192 to the wall thickness 244 of the inner tube 188 is less than about 2:1 at the first end 200 of the inner tube 188. In some examples, the third ratio 240 is greater than about 2:1, between about 2:1 and about 1:1, between about 4:3 and about 3:4, or any other range. In some cases, the first ratio 220 can be about 3:1 at the first chamber 168, where the second ratio 232 is greater than 3:1 at the second chamber, and the third ratio 240 is less than 3:1 at the first end 200 of the inner tube 188. In other examples, the first ratio 220 can be any ratio to correspond with the strength needed for a given pressure, and the same can be said for the second ratio 232 and the third ratio 240. The ratio of the wall thickness 224 of the outer tube 192 to the wall thickness of the inner tube 188 may be designed to accommodate for the highest working pressure the hydraulic cylinder encounters.

Using multiple materials in a hydraulic cylinder can also allow for improved manufacturability. For example, forming internal grooves (e.g., seal grooves) and a port with carbon fiber requires more complex forms and wrapping techniques. By using an inner tube made of metal, internal features can be more easily manufactured. For example, as illustrated in FIG. 4, the inner tube 188 includes a set of grooves 241 formed in the interior surface 196 and the port 204 extends through the inner tube 188 from the outer tube 192 to the interior surface 196 of the inner tube 188. A first groove 243 is provided at the port 204 to create a space for the hydraulic fluid. A second groove 245 is provided to receive the rod seal 180 to prevent fluid from leaking past the piston rod 164 of the piston 156.

As mentioned above, an outer tube is a first material (e.g., carbon fiber), and an inner tube is a second material (e.g., aluminum, steel, titanium, etc.). For example, FIG. 4 shows the hydraulic cylinder 152 having the outer tube 192 and the inner tube 188. The outer tube 192 is made from carbon fiber, and the inner tube 188 is made from a metallic layer (e.g., aluminum, steel, etc.). The outer tube 192 allows the hydraulic cylinder 152 to reduce weight while providing strength. Further, the inner tube 188 allows the hydraulic cylinder 152 to improve wear and friction to promote longevity of the hydraulic tool 100. In some cases, the inner tube 188 can be the same material as the outer tube 192. For example, the inner tube 188 can be made from carbon fiber with a coating (e.g., nickel-based, diamond chrome, etc.) and the outer tube 192 can also be made from carbon fiber.

In some aspects, the inner tube may be made from specific metallic alloys selected for their mechanical properties and compatibility with hydraulic fluids. For example, the inner tube may be made from 6061 aluminum alloy, which provides good corrosion resistance and machinability. In other examples, the inner tube may be made from 7075 aluminum alloy, which provides higher strength. In some cases, the inner tube may be made from 4140 steel, which provides high strength and wear resistance. In other cases, the inner tube may be made from titanium alloys, such as Ti-6Al-4V, which provide high strength-to-weight ratio and corrosion resistance. In some examples, surface treatments or coatings may be applied to the interior surface of the inner tube to improve wear resistance and reduce friction. For example, hard anodizing may be applied to aluminum inner tubes to create a hard, wear-resistant oxide layer. Nickel plating or electroless nickel plating may be applied to provide a hard, corrosion-resistant surface. Chrome plating may be applied to provide a hard, low-friction surface. Diamond-like carbon (DLC) coating may be applied to provide extremely low friction and high wear resistance. These surface treatments may extend the service life of the hydraulic cylinder by reducing wear between the piston and the interior surface of the inner tube.

An outer tube of a multi-component hydraulic cylinder can include a first layer of material having strands oriented with a first wrap angle relative to a cylinder axis to provide strength. Referring to FIGS. 3-4, the outer tube 192 includes a first layer 248 having carbon fiber strands oriented with a first wrap angle 252 relative to the cylinder axis 216. For example, FIGS. 3-4 shows the first layer 248 having a first wrap angle 252 of about 90 degrees. In other examples, the first wrap angle 252 is between about 45 to 50 degrees, about 50 to 55 degrees, about 55 to 60 degrees, or any angle greater than or equal to 0 degrees and less than or equal to 180 degrees. The first wrap angle 252 provides initial strength around the inner tube 188. In some examples, the first wrap angle 252 can be modified along the cylinder axis 216 (i.e., the first wrap angle 252 can be variable along the cylinder axis 216).

An outer tube of a multi-component hydraulic cylinder can also include a second layer of material in addition to the first layer of material. The second layer of material can have strands oriented with a second wrap angle relative to a cylinder axis that is different from the first wrap angle. Referring to FIGS. 3-4, the outer tube 192 includes a second layer 256 having carbon fiber strands oriented with a second wrap angle 260 relative to the cylinder axis 216. For example, FIGS. 3-4 shows the second layer 256 having a second wrap angle 260 of about 45 degrees. In other examples, the second wrap angle 260 is between about 20 to 25 degrees, about 25 to 30 degrees, about 30 to 35 degrees, or any angle greater than or equal to 0 degrees and less than or equal to 180 degrees and is different from the first wrap angle 252. The second wrap angle 260 provides additional strength at a different wrap angle from the first wrap angle 252. For example, carbon filaments used in carbon fiber wraps or layers provide directional strength because they are strong in tension, but comparatively weak under compression or lateral loading. Circumferential wraps provide increased hoop strength but contribute less to axial strength, whereas axial wraps provide high axial strength but less hoop strength. By varying the wrap angle, both radial and axial strength can be tuned according to the needs of a particular application. In some examples, the second wrap angle 260 can be modified along the cylinder axis 216 to provide additional strength at weak points (i.e., the second wrap angle 260 can be variable along the cylinder axis 216).

An outer tube of a multi-component hydraulic cylinder can include intermediate layers (i.e., more than two layers of material). Referring to FIG. 4, the outer tube 192 has two layers 248 and 256 of material. In some cases, the outer tube 192 can include three layers of material. In some cases, the outer tube 192 can include four layers of material, or any number of layers to provide strength sufficient support the working pressures of the hydraulic cylinder 152.

An inner tube of a multi-component hydraulic cylinder can include a coating to improve wear and friction caused by an outer tube. In some cases, an inner tube of a multi-component hydraulic cylinder can include a coating for retention with the outer tube. For example, the coating can be oil based (e.g., grease), metallic coatings (e.g., aluminum or zinc), ceramic coatings, or polymer coatings. In some cases, the coating is applied to the inner tube 188 before a material (e.g., carbon fiber) is wrapped around the inner tube 188 to define the outer tube 192.

In some aspects, the thickness of the coating applied to the inner tube may vary depending on the application requirements. For example, the coating thickness may range from a few micrometers to several hundred micrometers. Thicker coatings may provide improved wear resistance and longer service life, while thinner coatings may be used where dimensional tolerances are tight. In some cases, the coating may be applied using spray application methods, such as thermal spray or plasma spray. In other cases, the coating may be applied using dip coating methods, where the inner tube is immersed in a coating solution. In some examples, the coating may be applied using electroplating or electroless plating processes. In some aspects, the coating may extend along the entire length of the inner tube. In other aspects, the coating may extend along only a portion of the inner tube, such as the regions where the piston head and piston seal contact the interior surface. Selective coating application may reduce manufacturing costs while still providing wear protection in the areas that experience the most contact and friction.

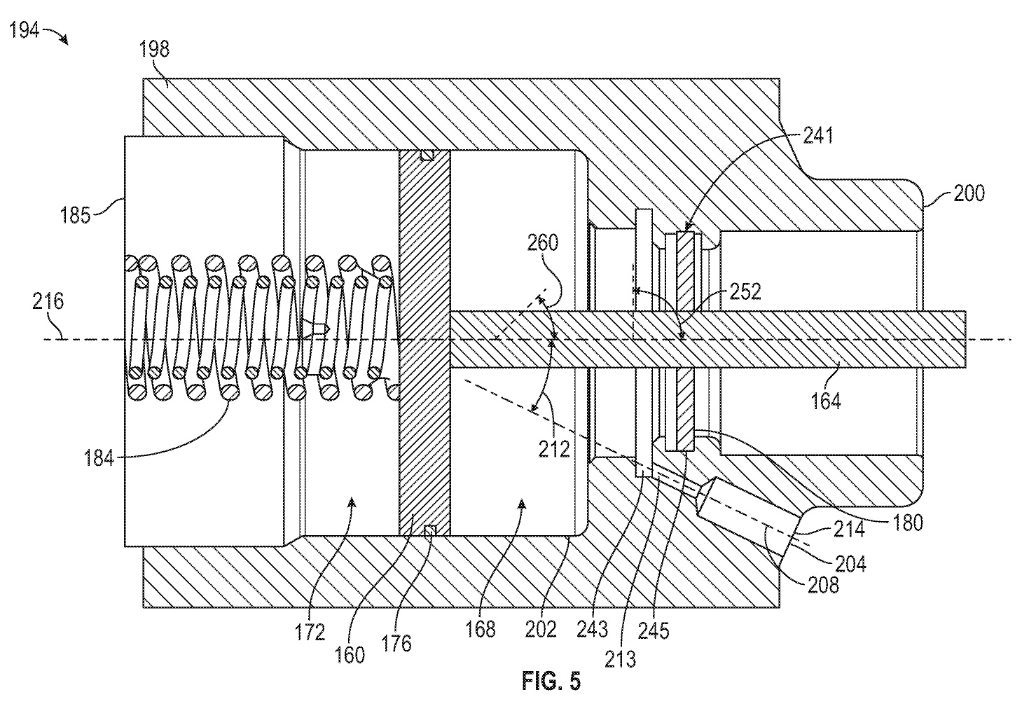

FIG. 5 illustrates another example of a hydraulic actuator 194 for use with the hydraulic tool of FIG. 1. To that end, features of the hydraulic actuator 194 described below include reference numbers that are generally similar to those used in FIGS. 1-4, and discussion applies to similar named and numbered items below, unless otherwise noted or required. For example, the hydraulic actuator 194 includes a hydraulic cylinder 198 that receives a piston 156 having a piston head 160 and a piston rod 164.

The hydraulic cylinder 198 is made entirely from carbon fiber. The hydraulic cylinder 198 can be formed using various manufacturing techniques. In some cases, the carbon fiber is wrapped in multiple layers around a mandrel that is shaped like the first chamber 168 and the second chamber 172, with each layer having carbon fiber strands oriented at a wrap angle relative to the cylinder axis 216. For example, a first layer can have carbon fiber strands oriented at the first wrap angle 252 and a second layer may have carbon fiber strands oriented at the second wrap angle 260. In some examples, the layer alternate between the first wrap angle 252 and the second wrap angle 260 to provide both hoop strength and axial strength. In other examples, additional layers are provided at other wrap angles to further tune the strength characteristics of the cylinder.

In other examples, the hydraulic cylinder 198 is formed from a carbon fiber blank. For example, the hydraulic cylinder 198 is machined from a solid carbon fiber block or rod to achieve the desired geometry. In other cases, the hydraulic cylinder 198 is formed from pressed carbon fiber. For example, carbon fiber material is placed in a mold and subjected to heat and pressure to form the cylinder shape. In some examples, the pressed carbon fiber includes chopped carbon fibers, carbon fiber mats, or a combination thereof.

In some examples, the hydraulic cylinder 198 may be formed by wrapping carbon fibers around a form or mandrel. The form may include pins, rods, or other features that correspond to openings in the cylinder, such as the port 204. During the wrapping process, the carbon fibers may be wrapped around these features so that when the form is removed after curing, the port 204 or other openings remain in the hydraulic cylinder 198. In some cases, the pins or rods on the form may be oriented at the oblique angle 212 relative to the cylinder axis 216 to create the port 204 at the desired angle. That is, the port 204 can be formed during the wrapping process. For example, a two-piece form may be used where a first form and a second form are coupled to one another so that the port 204 is formed by the forms. The first form corresponds with a chamber of the cylinder, and the second form corresponds with the port 204. In some examples, the second form includes a core or pin that defines the shape of the port 204 during the wrapping process. In some examples, the port 204 is formed by placing a removable insert in the first form or the second form that is removed after curing to leave the port opening. In other examples, the port 204 is partially formed during wrapping process and then finished by drilling or machining to achieve final dimensions.

In other examples, the port 204 may be formed by drilling into the carbon fiber material after the hydraulic cylinder 198 is formed. For example, a drill bit may be used to create the port 204 at the oblique angle 212 relative to the cylinder axis 216. In some cases, the drilled port 204 may be lined with a metal insert or bushing to provide a threaded connection for a valve or other flow control element.

In some aspects, the piston 156 is configured to seal against an interior surface 202 of the hydraulic cylinder 198 (e.g., directly against the carbon fiber). The piston seal 176 is selected or configured to accommodate the surface characteristics of carbon fiber. In some cases, the piston seal 176 is made from a softer or more compliant material that conforms to minor surface irregularities in the carbon fiber. For example, the piston seal 176 can be made from polytetrafluoroethylene (PTFE), polyurethane, nitrile rubber, or other elastomeric materials. In some examples, the piston seal 176 includes a composite construction having a softer sealing lip and a harder backing element to provide both sealing and structural support.

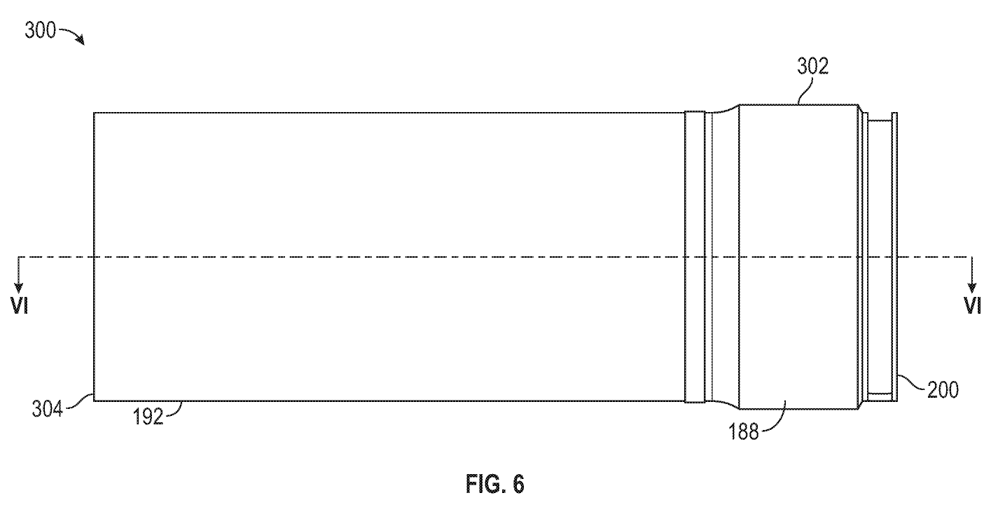

FIG. 6 illustrates another example of a multi-component hydraulic actuator 300, which is another example of a hydraulic actuator according to aspects of the disclosure for use with the hydraulic tool of FIG. 1. To that end, features of the hydraulic actuator 300 described below include reference numbers that are generally similar to those used in FIGS. 1-5, and discussion applies to similar named and numbered items below, unless otherwise noted or required. For example, the hydraulic actuator 300 includes a hydraulic cylinder 302 that receives a piston 156 having a piston head 160 and a piston rod 164.

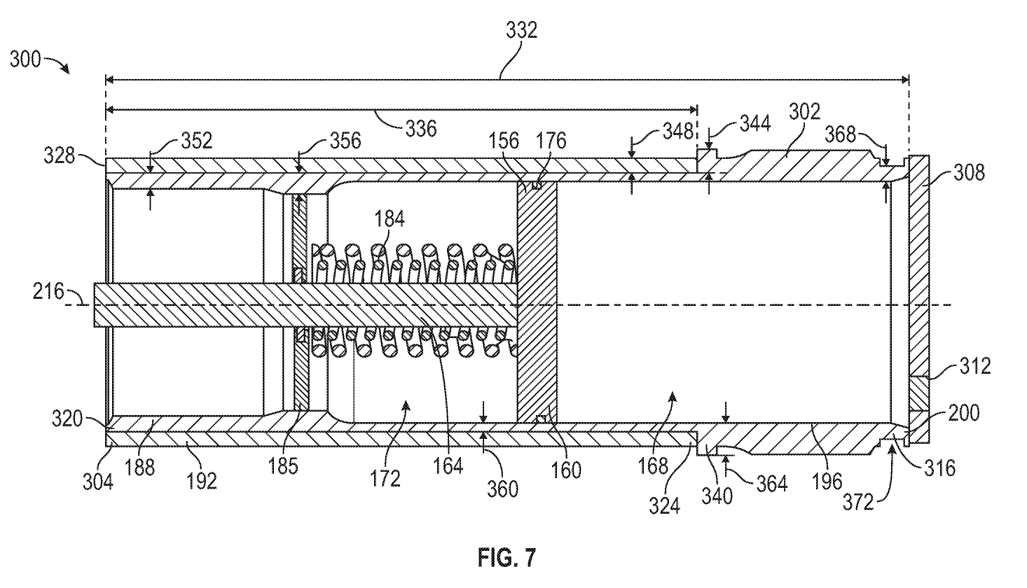

A hydraulic actuator can include a first end configured as an end wall to couple to a valve and a second end configured to receive a tool head of a hydraulic tool. For example, FIG. 7 illustrates the hydraulic actuator 300 having a first end 200 and a second end 304. The first end 200 is configured as an end wall 308. The end wall 308 contains a valve 312 to control flow of a hydraulic fluid into and out of the hydraulic actuator 300. In some examples, the first end 200 can be configured differently (e.g., as an interior wall). The second end 304 is configured to receive a tool head. The tool head can be coupled to the second end 304 by press-fit, threading, etc.

A piston is moveably disposed within a hydraulic cylinder to define a first chamber and a second chamber. For example, the hydraulic cylinder 302 receives the piston 156. A first chamber 168 is defined between the piston head 160 and the end wall 308. The first chamber 168 is in fluid communication with a pump to pump fluid into the first chamber 168 to move the piston head 160 in a first direction (e.g., extension of the piston). For example, fluid is pumped into the first chamber 168. The end wall 308 includes the valve 312 to allow fluid to flow into the first chamber 168. A second chamber 172 is defined between the piston head 160 and a retention cap 185. The second chamber 172 receives a return mechanism 184 (e.g., a spring). The retention cap 185 secures the return mechanism 184 within the second chamber 172.

A hydraulic cylinder can be configured as a multi-component hydraulic cylinder to balance the weight of a hydraulic tool with strength by including an inner tube and an outer tube. For example, FIGS. 6 and 7 illustrate the hydraulic cylinder 302 having an inner tube 188 and an outer tube 192. The inner tube 188 defines an interior surface 196 that engages the piston 156 and extends from a first end 316 (e.g., first inner tube end) to a second end 320 (e.g., second inner tube end). The outer tube 192 defines a first end 324 (e.g., first outer tube end) and a second end 328 (e.g., second outer tube end) and is sleeved onto the inner tube 188. The first end 316 of the inner tube 188 extends out of the outer tube 192 to allow a valve to be coupled to the hydraulic actuator 300. The second end 320 of the inner tube 188 aligns with the second end 328 of the outer tube 192.

In other embodiments, the arrangement shown in FIG. 7 can be different. For example, the first end 316 of the inner tube 188 can be connected to the working head 108. In some embodiments, the first end 316 of the inner tube 188 can be connected to a reservoir 148.

A length of an inner tube and the length of an outer tube can have a ratio of about 4: 3. For example, the inner tube 188 has a length 332 and the outer tube 192 has a length 336. The ratio between the inner tube 188 and the outer tube is about 4:3. In other examples, the ratio can be different. For example, the ratio can be between about 5:1 and about 3:1, between about 2:1 and about 3:2, greater than about 4:3, or another range to balance weight of the hydraulic tool with the strength of the inner tube and the outer tube.

An inner tube can define a flange to receive an outer tube. For example, the inner tube 188 defines a flange 340. The flange 340 abuts the outer tube 192 and defines a thickness 344. As shown in FIG. 6, the thickness 344 of the flange 340 and a thickness 348 of the outer tube 192 are both measured in a direction perpendicular to the cylinder axis 216. The flange 340 extends past the outer tube 192 such that the thickness 344 of the flange 340 is greater than the thickness 348 of the outer tube 192. In some examples, the flange 340 can be the same thickness as the outer tube 192. The ratio of the thickness 344 of the flange 340 and the thickness 348 of the outer tube 192 is between about 4:3 and about 1:1. In some examples, the ratio of the thickness 344 of the flange 340 and the thickness 348 of the outer tube 192 is between about 5:1 and about 4:1, between about 4:1 and about 2:1, between about 2:1 and about 4:3, greater than about 4:3, or any other range to allow the inner tube 188 to receive the outer tube 192.

An inner tube can define variable wall thickness to reduce weight while maintaining strength in areas subject to high pressures. For example, the inner tube 188 has a first thickness 352 at the second end 320. The inner tube 188 has a second thickness 356 at the retention cap 185. The inner tube 188 has a third thickness 360 in the first chamber 168 and the second chamber 172. The inner tube 188 has a fourth thickness 364 at the flange 340. The inner tube 188 has a fifth thickness 368 to define a groove 372 at the first end 316. The first thickness 352 of the inner tube 188 and the thickness 348 of the outer tube 192 have a ratio of about 1:1. In some examples, the ratio of first thickness 352 of the inner tube 188 and the thickness 348 of the outer tube 192 is between about 5:1 and about 4:1, between about 4:1 and about 2:1, between about 2:1 and about 4:3, greater than 1:1, or any other range. The second thickness 356 of the inner tube 188 and the thickness 348 of the outer tube 192 have a ratio of about 4:3. In some examples, the ratio of the second thickness 356 of the inner tube 188 and the thickness 348 of the outer tube 192 is between about 5:1 and about 4:1, between about 4:1 and about 2:1, between about 2:1 and about 4:3, greater than about 4:3, or any other range. The third thickness 360 of the inner tube 188 and the thickness 348 of the outer tube 192 have a ratio of about 1:2. In some examples, the ratio of the third thickness 360 of the inner tube 188 and the thickness 348 of the outer tube 192 is between about 1:1 and about 3:4, between about 3:4 and about 1:2, between about 1:2 and about 4:3, or any other range. The fourth thickness 364 of the inner tube 188 and the thickness 348 of the outer tube 192 have a ratio of about 2:1. In some examples, the ratio of the fourth thickness 364 of the inner tube 188 and the thickness 348 of the outer tube 192 is between about 4:1 and about 2:1, between about 2:1 and about 4:3, between about 4:3 and about 1:1, greater than 1:1, or any other range. The fifth thickness 368 of the inner tube 188 and the thickness 348 of the outer tube 192 have a ratio of about 1:1. In some examples, the ratio of the thickness 368 of the inner tube 188 and the thickness 348 of the outer tube 192 is between about 5:1 and about 4:1, between about 4:1 and about 2:1, between about 2:1 and about 4:3, greater than 1:1, or any other range.

In some aspects, the variable wall thickness of the inner tube may be achieved through machining processes. For example, the inner tube may be machined from a solid tube or bar stock to create the desired thickness profile along its length. In other examples, the inner tube may be formed with variable thickness using forging, extrusion, or other forming processes, with subsequent machining to achieve final dimensions. In some cases, transitions between different thicknesses may be gradual, with tapered or radiused transitions that reduce stress concentrations. In other cases, transitions between thicknesses may be stepped, with distinct changes in wall thickness at specific locations along the inner tube. The selection of gradual or stepped transitions may depend on manufacturing considerations, stress distribution requirements, and the specific geometry of the hydraulic cylinder. In some examples, the thickness profile of the inner tube may be optimized for specific pressure distributions within the hydraulic cylinder. For example, regions that experience higher hydraulic pressures may have thicker walls, while regions that experience lower pressures may have thinner walls to reduce weight. Finite element analysis or other computational methods may be used to determine thickness profiles based on expected operating conditions.

As mentioned above, an inner tube can be made of a first material (e.g., aluminum, steel, titanium, etc.). An outer tube can be made of a second material (e.g., carbon fiber). For example, the inner tube 188 is made from a metallic layer (e.g., aluminum, steel, etc.), and the outer tube 192 is made from carbon fiber. The outer tube 192 allows the hydraulic cylinder 302 to reduce weight while providing strength. In some cases, the inner tube 188 can be made as the same material as the outer tube 192 (e.g., carbon fiber with a coating).

An outer tube can be made from carbon fiber. For example, the outer tube 192 is made from carbon fiber. In some examples, the outer tube 192 can be wrapped around the inner tube 188 at different wrap angles (see angles 252 and 260 in FIG. 3). In other examples, the outer tube 192 is received on the inner tube 188 by press fit. In some examples, the outer tube 192 can include multiple layers with different wrap angles (see FIG. 4), as generally discussed above.

Disclosed examples described above with reference to the accompanying drawings, in which some, but not all of the disclosed examples are shown. Indeed, several different examples may be provided and should not be construed as limited to the examples set forth above. Rather, these examples are provided so that this disclosure will be thorough and complete and will fully convey the scope of the disclosure to those skilled in the art. It is understood that the various features and examples described above in the present disclosure may be mixed or interchanged into different combinations of features and examples. In other words, the specific combinations of features disclosed above are not intended to be limiting but are purely for the sake of illustrating examples. It is to be understood that the disclosure is not limited in its application to the details of construction and the arrangement of components set forth in the above description or illustrated in the drawings. The disclosure is capable of other examples and of being practiced or of being carried out in various ways. Also, it is to be understood that the phraseology and terminology used above is for the purpose of description and should not be regarded as limiting. The use of “including,” “comprising,” or “having” and variations thereof above is meant to encompass the items listed thereafter and equivalents thereof as well as additional items.

The above discussion is presented to enable a person skilled in the art to make and use examples of the disclosure. Various modifications to the illustrated examples will be readily apparent to those skilled in the art, and the generic principles above can be applied to other examples and applications without departing from examples of the disclosure. Thus, examples of the disclosure are not intended to be limited to examples shown, but are to be accorded the widest scope consistent with the principles and features disclosed above. The above detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided above have many useful alternatives and fall within the scope of embodiments of the disclosure.

As used above, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used above, unless otherwise limited or defined, “substantially parallel” indicates a direction that is within ± 12 degrees of a reference direction (e.g., within ± 6 degrees), inclusive. Similarly, unless otherwise limited or defined, “substantially perpendicular” similarly indicates a direction that is within ± 12 degrees of perpendicular a reference direction (e.g., within ± 6 degrees), inclusive.

The term “about,” as used above, refers to variation in the numerical quantity that may occur, for example, through typical measuring and manufacturing procedures used for power tools may include examples of the disclosure above; through inadvertent error in these procedures; through differences in the manufacture, source, or purity of the ingredients used to make the compositions or mixtures or carry out the methods; and the like. In the disclosure above, the terms “near,” “about,” and “approximately” refer to a range of values ± 15% of the numeric value that the term precedes.

In some implementations, devices or systems disclosed above can be utilized or installed using methods embodying aspects of the disclosure. Correspondingly, description above of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion above of any method of manufacturing or using a particular device or system, including installing the device or system, is intended to inherently include disclosure, as examples of the disclosure, of the utilized features and implemented capabilities of such device or system.

As also used above, unless otherwise defined or limited, ordinal numbers are used for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

We claim:

1. A hydraulic cylinder for a hydraulic tool, the hydraulic cylinder comprising:
a cylinder defining an axis and including:
a tube comprising carbon fiber, and
a liner disposed within the tube to define an interior surface of the cylinder, the liner including a first end that extends out of the tube, the first end defining a port extending through the liner at an oblique angle relative to the axis; and
a piston moveably disposed within the cylinder, the piston including a piston head that seals against the interior surface of the liner and a rod that extends out of the cylinder.

2. The hydraulic cylinder of claim 1, wherein the piston head separates an interior space of the cylinder into a first chamber and a second chamber, and
wherein the port is provided at the first chamber.

3. The hydraulic cylinder of claim 2, wherein the rod extends into the first chamber and through the first end of the liner.

4. The hydraulic cylinder of claim 3, wherein the cylinder is provided within a housing of a power tool and the first end of the liner is configured to couple to a working head of the power tool.

5. The hydraulic cylinder of claim 3, wherein the second chamber includes a return mechanism and a retention cap secures the return mechanism within the second chamber.

6. The hydraulic cylinder of claim 2, wherein a first ratio of a wall thickness of the tube to a wall thickness of the liner is about 2:1 at the first chamber.

7. The hydraulic cylinder of claim 6, wherein a second ratio of the wall thickness of the tube to the wall thickness of the liner is greater than 2:1 at the second chamber, and
wherein a third ratio of the wall thickness of the tube to the wall thickness of the liner is less than 2:1 at the first end of the liner.

8. The hydraulic cylinder of claim 1, wherein the liner is a metallic tube that is disposed within the tube.

9. The hydraulic cylinder of claim 1, wherein the tube includes a first layer having carbon fiber strands oriented with a first wrap angle relative to the axis and a second layer having carbon fiber strands oriented with a second wrap angle relative to the axis that is different from the first wrap angle.

10. The hydraulic cylinder of claim 2, wherein an end of the tube is disposed along the port in an axial direction parallel to the axis.

11. A hydraulic tool, comprising:
a housing;
a working head coupled to the housing;
a hydraulic cylinder defining a cylinder axis and including:
a liner defining an interior surface of the hydraulic cylinder; and
a tube disposed around the liner, the tube including a first layer having carbon fiber strands oriented with a first wrap angle relative to the cylinder axis and a second layer having carbon fiber strands with a second wrap angle relative to the cylinder axis;
a piston moveably disposed within the hydraulic cylinder, the piston including a piston head that seals against the interior surface of the liner to separate an interior space of the hydraulic cylinder into a first chamber and a second chamber, and
a port defined in the liner.

12. The hydraulic tool of claim 11, wherein the port is provided at the first chamber and extends at an oblique angle from the cylinder axis so that an axis of the port intersects the cylinder axis.

13. The hydraulic tool of claim 12, wherein the port extends through the liner from a first end to a second end so that the first end of the port disposed within the tube and the second end disposed outside the tube.

14. The hydraulic tool of claim 11, wherein the first wrap angle is about 90 degrees.

15. The hydraulic tool of claim 14, wherein the second wrap angle is about 45 degrees.

16. The hydraulic tool of claim 11, wherein the first wrap angle is variable along the cylinder axis.

17. The hydraulic tool of claim 11, wherein the liner is made from carbon fiber with a coating that is at least one of oil-based, metallic, ceramic, or polymer.

18. A hydraulic cylinder for a hydraulic tool, the hydraulic cylinder comprising:
a cylinder defining an axis and including:
an outer tube comprising carbon fiber, and
an inner tube defining an interior surface of the cylinder, the inner tube being received within the outer tube and including a variable wall thickness; and
a piston moveably disposed within the cylinder and including:
a piston head sealing against the interior surface of the inner tube and separating an interior space of the cylinder into a first chamber and a second chamber, and a rod extending out of the cylinder,
the inner tube defining a first length between a first inner tube end and a second inner tube end and the outer tube defining a second length between a first outer tube end and a second outer tube end, the first length and the second length defining a ratio greater than about 4:3.

19. The hydraulic cylinder of claim 18, wherein the inner tube defines a first end that extends out of the outer tube and a second end that aligns with a second end of the outer tube.

20. The hydraulic cylinder of claim 19, wherein the first end of the inner tube defines a flange that abuts the outer tube.
